(19) United States
(12) Patent Application Publication
(10) Pub. No.: US 2026/0230275 A1
(43) Pub. Date: Aug. 6, 2026

(54) SIGNALING ASSOCIATED WITH UPLINK RESOURCES FOR SENSING

(71) Applicant: QUALCOMM Incorporated, San Diego, CA (US)

(72) Inventors: Preeti KUMARI, San Diego, CA (US); Hong CHENG, Basking Ridge, NJ (US); Kapil GULATI, Belle Mead, NJ (US); Shijun WU, San Diego, CA (US); Stelios STEFANATOS, San Diego, CA (US); Junyi LI, Greentown, PA (US)

(21) Appl. No.: 19/147,098

(22) PCT Filed: Jan. 31, 2024
(86) PCT No.: PCT/US2024/013852

§ 371 Date: Jul. 10, 2025

(30) Foreign Application Priority Data
Feb. 15, 2023 (GR) 20230100120

(51) Int. Cl. H04L 5/00

(52) U.S. Cl. CPC H04L 5/0053

(57) ABSTRACT

Various aspects of the present disclosure generally relate to wireless communication. In some aspects, a user equipment (UE) may transmit, to a network node, an indication of a transmission configuration pattern for sensing using uplink resources. The UE may receive, from the network node, an indication of a transmit resource allocation for sensing, the transmit resource allocation for sensing being based at least in part on the transmission configuration pattern for sensing using uplink resources. Numerous other aspects are described.

### CROSS-REFERENCE TO RELATED APPLICATION

This Patent Application claims priority to Greek Patent Application No. 20230100120, filed on Feb. 15, 2023, entitled “SIGNALING ASSOCIATED WITH UPLINK RESOURCES FOR SENSING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for signaling associated with uplink resources for sensing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to transmit, to a network node, an indication of a transmission configuration pattern for sensing using uplink resources. The one or more processors may be configured to receive, from the network node, an indication of a transmit resource allocation for sensing, the transmit resource allocation for sensing being based at least in part on the transmission configuration pattern for sensing using uplink resources.

Some aspects described herein relate to an apparatus for wireless communication at a network node. The apparatus may include a memory and one or more processors coupled to the memory. The one or more processors may be configured to receive, from a UE, an indication of a transmission configuration pattern for sensing using uplink resources. The one or more processors may be configured to transmit, to the UE, an indication of a transmit resource allocation for sensing, the transmit resource allocation for sensing being based at least in part on the transmission configuration pattern for sensing using uplink resources.

Some aspects described herein relate to a method of wireless communication performed by a UE. The method may include transmitting, to a network node, an indication of a transmission configuration pattern for sensing using uplink resources. The method may include receiving, from the network node, an indication of a transmit resource allocation for sensing, the transmit resource allocation for sensing being based at least in part on the transmission configuration pattern for sensing using uplink resources.

Some aspects described herein relate to a method of wireless communication performed by a network node. The method may include receiving, from a UE, an indication of a transmission configuration pattern for sensing using uplink resources. The method may include transmitting, to the UE, an indication of a transmit resource allocation for sensing, the transmit resource allocation for sensing being based at least in part on the transmission configuration pattern for sensing using uplink resources.

Some aspects described herein relate to a non-transitory computer-readable medium that stores a set of instructions for wireless communication by a UE. The set of instructions, when executed by one or more processors of the UE, may cause the UE to transmit, to a network node, an indication of a transmission configuration pattern for sensing using uplink resources. The set of instructions, when executed by one or more processors of the UE, may cause the UE to receive, from the network node, an indication of a transmit resource allocation for sensing, the transmit resource allocation for sensing being based at least in part on the transmission configuration pattern for sensing using uplink resources.

Some aspects described herein relate to a non-transitory computer-readable medium that stores a set of instructions for wireless communication by a network node. The set of instructions, when executed by one or more processors of the network node, may cause the network node to receive, from a UE, an indication of a transmission configuration pattern for sensing using uplink resources. The set of instructions, when executed by one or more processors of the network node, may cause the network node to transmit, to the UE, an indication of a transmit resource allocation for sensing, the transmit resource allocation for sensing being based at least in part on the transmission configuration pattern for sensing using uplink resources.

Some aspects described herein relate to an apparatus for wireless communication. The apparatus may include means for transmitting, to a network node, an indication of a transmission configuration pattern for sensing using uplink resources. The apparatus may include means for receiving, from the network node, an indication of a transmit resource allocation for sensing, the transmit resource allocation for sensing being based at least in part on the transmission configuration pattern for sensing using uplink resources.

Some aspects described herein relate to an apparatus for wireless communication. The apparatus may include means for receiving, from a UE, an indication of a transmission configuration pattern for sensing using uplink resources. The apparatus may include means for transmitting, to the UE, an indication of a transmit resource allocation for sensing, the transmit resource allocation for sensing being based at least in part on the transmission configuration pattern for sensing using uplink resources.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a joint communication and radar (JCR) system, in accordance with the present disclosure.

FIG. 5 is a diagram illustrating an example of vehicle sensing, in accordance with the present disclosure.

FIG. 6 is a diagram illustrating an example of uplink sensing, in accordance with the present disclosure.

FIG. 7 is a diagram illustrating an example associated with signaling associated with uplink resources for sensing, in accordance with the present disclosure.

FIGS. 8-9 are diagrams illustrating example processes associated with signaling associated with uplink resources for sensing, in accordance with the present disclosure.

FIGS. 10-11 are diagrams of example apparatuses for wireless communication, in accordance with the present disclosure.

### DETAILED DESCRIPTION

(Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

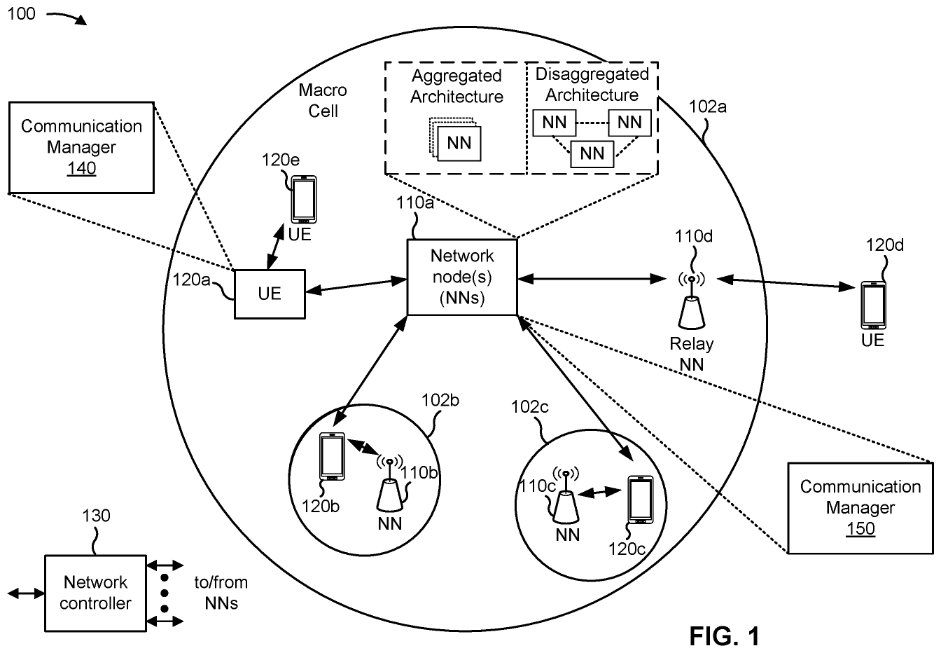

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHz), and FR5 (114.25 GHz-300 GHz).

Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network node, an indication of a transmission configuration pattern for sensing using uplink resources; and receive, from the network node, an indication of a transmit resource allocation for sensing, the transmit resource allocation for sensing being based at least in part on the transmission configuration pattern for sensing using uplink resources. Additionally, or alternatively, the communication manager 140 may perform one or more other operations described herein.

In some aspects, a network node (e.g., network node 110) may include a communication manager 150. As described in more detail elsewhere herein, the communication manager 150 may receive, from a UE, an indication of a transmission configuration pattern for sensing using uplink resources; and transmit, to the UE, an indication of a transmit resource allocation for sensing, the transmit resource allocation for sensing being based at least in part on the transmission configuration pattern for sensing using uplink resources. Additionally, or alternatively, the communication manager 150 may perform one or more other operations described herein.

As indicated above, FIG. 1 is provided as an example. Other examples may differ from what is described with regard to FIG. 1.

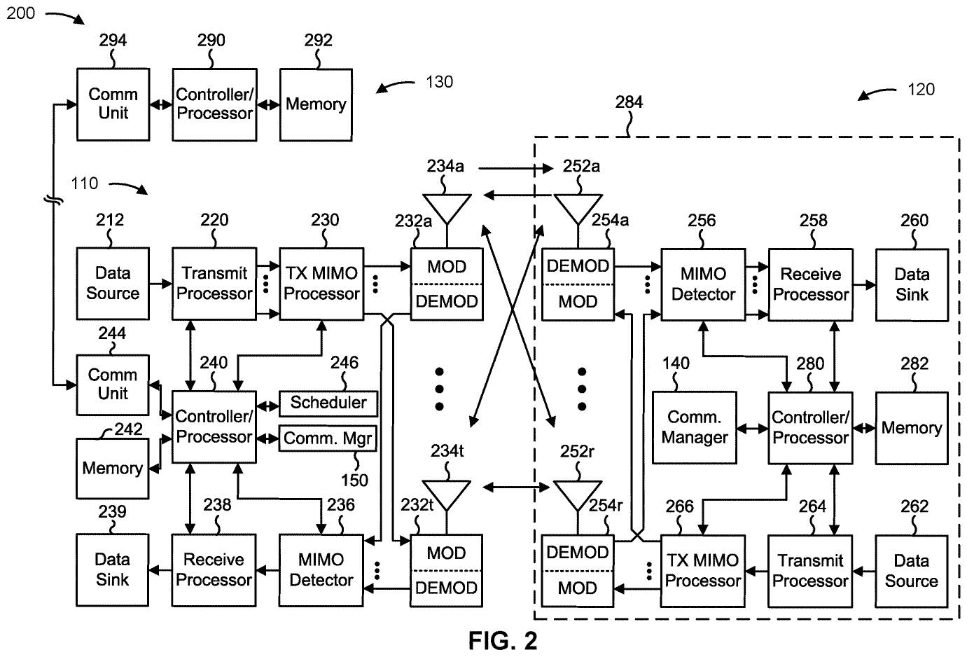

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

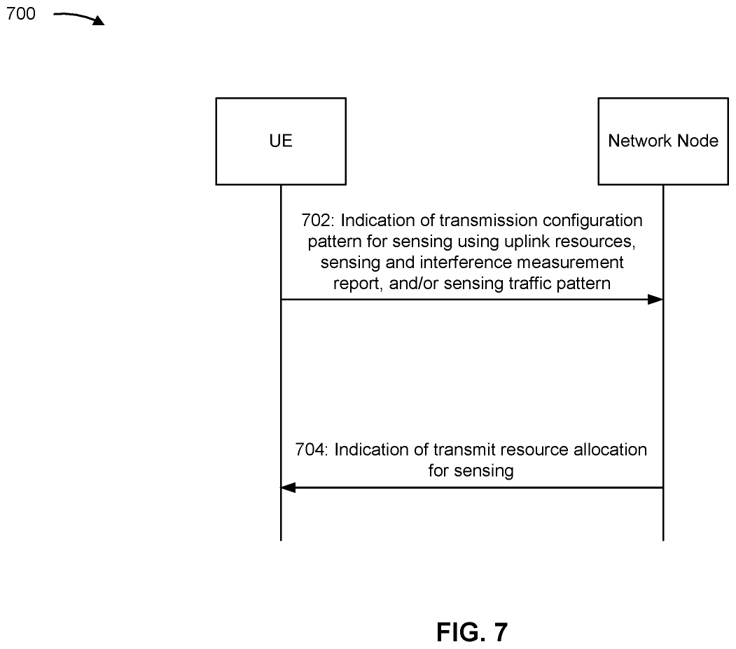

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

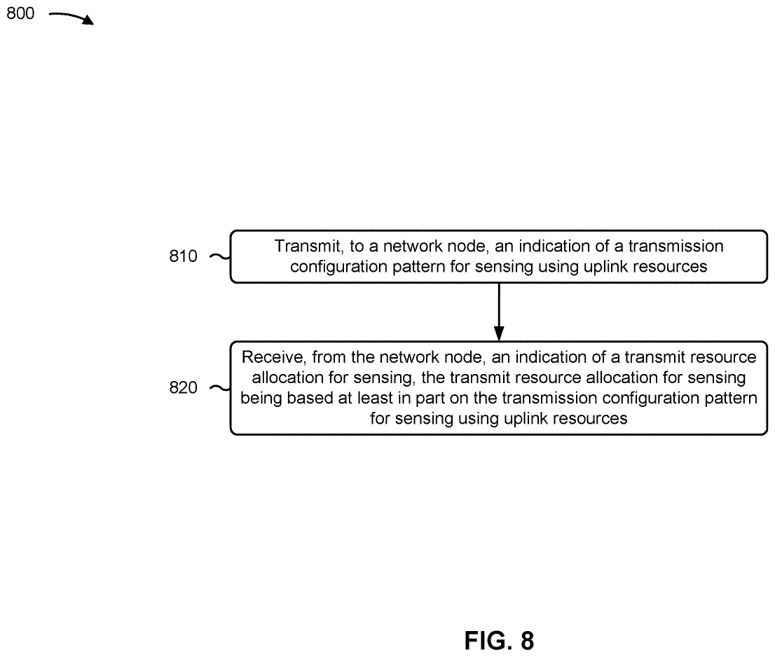

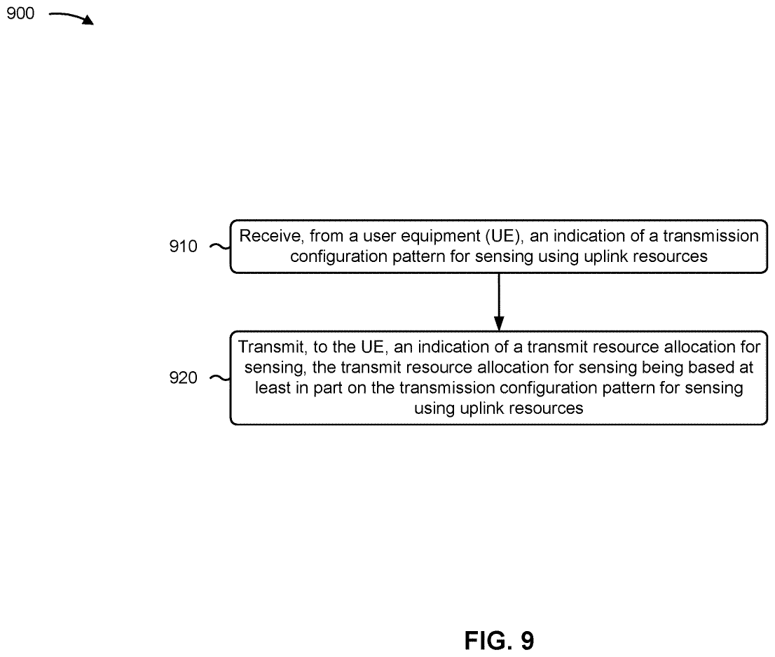

The controller/processor 240 of the network node 110, the controller/processor 280 of the UE 120, and/or any other component(s) of FIG. 2 may perform one or more techniques associated with signaling associated with uplink resources for sensing, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting, to a network node, an indication of a transmission configuration pattern for sensing using uplink resources; and/or means for receiving, from the network node, an indication of a transmit resource allocation for sensing, the transmit resource allocation for sensing being based at least in part on the transmission configuration pattern for sensing using uplink resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for receiving, from a UE, an indication of a transmission configuration pattern for sensing using uplink resources; and/or means for transmitting, to the UE, an indication of a transmit resource allocation for sensing, the transmit resource allocation for sensing being based at least in part on the transmission configuration pattern for sensing using uplink resources. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

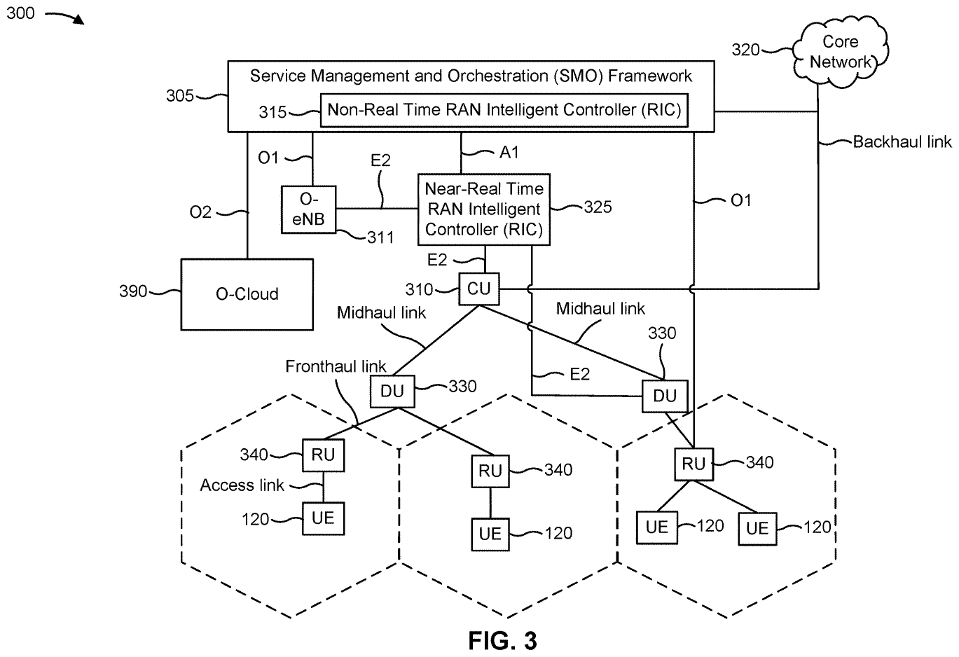

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions.

Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325.

The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

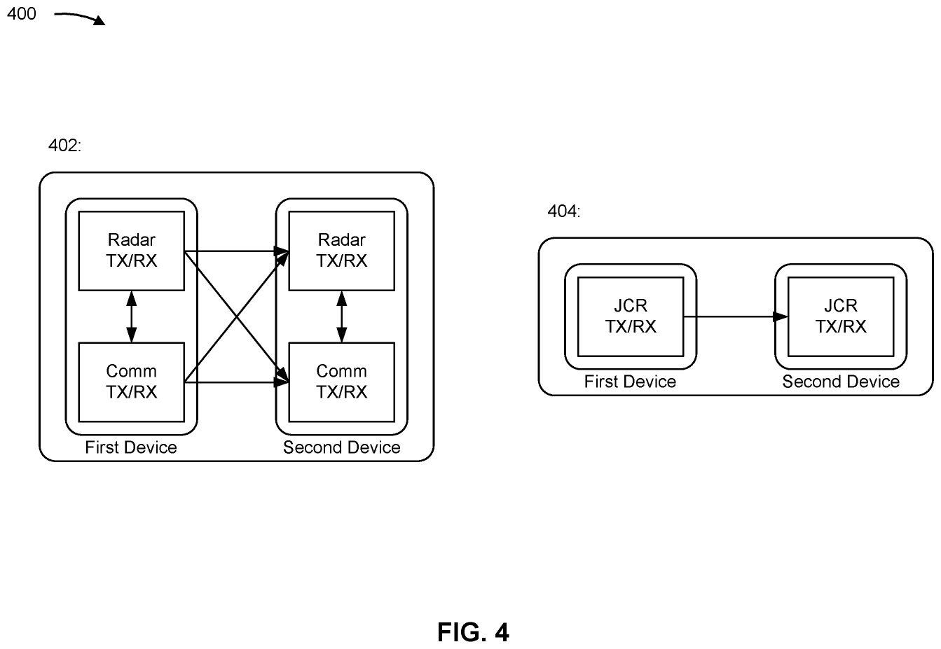

FIG. 4 is a diagram illustrating an example 400 of a joint communication and radar (JCR) system, in accordance with the present disclosure.

As shown by reference number 402, a JCR system may be a cooperative-based JCR system. A first device may be associated with a radar transmitter/receiver (TX/RX) and a communication TX/RX. A second device may be associated with a radar TX/RX and a communication TX/RX. Information may be shared between communication and radar systems, within the same device and/or between the first device and the second device, which may improve an overall performance. The information may be shared between the communication and radar systems, without significantly altering the core operation of the communication and radar systems.

As shown by reference number 404, a JCR system may be a co-design-based JCR system, which may involve a co-design of communication and radar systems. A first device may be associated with a JCR TX/RX. A second device may be associated with a JCR TX/RX. In the co-design-based JCR system, a common TX/RX per device may be used for both communication and radar functionalities. The co-design-based JCR system may require a significant modification to a TX waveform generation and an RX processing for the communication and radar systems.

A JCR system may be associated with a hardware reuse and a spectrum reuse. The JCR system may involve a communication system assisting a radar system, and/or the radar system assisting the communication system.

As indicated above, FIG. 4 is provided as an example. Other examples may differ from what is described with regard to FIG. 4.

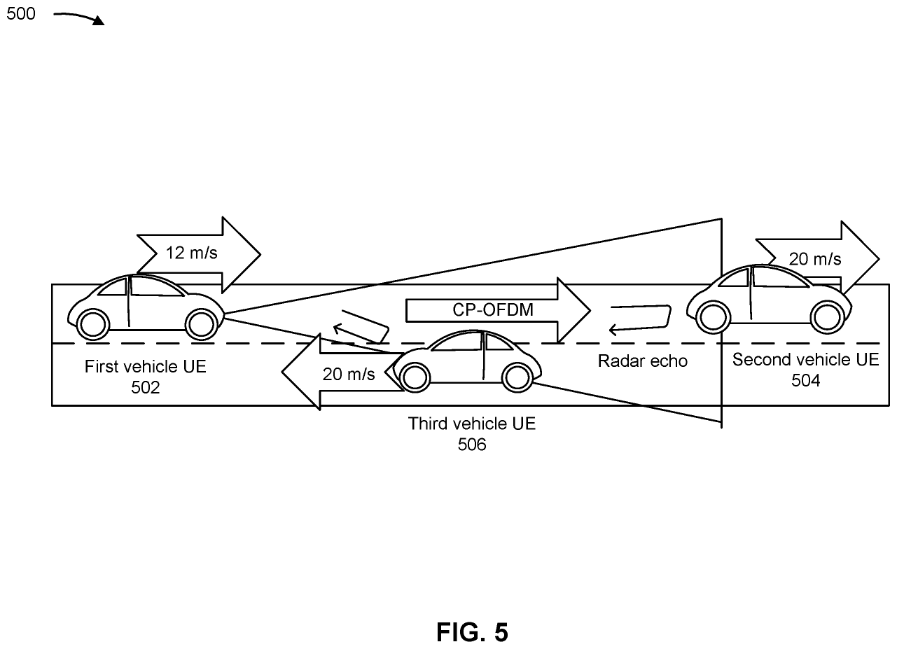

FIG. 5 is a diagram illustrating an example 500 of vehicle sensing, in accordance with the present disclosure.

As shown in FIG. 5, vehicle UEs may need to sense surrounding objects for automotive applications, such as collision avoidance. A first vehicle UE 502 may be traveling in a first direction at 12 meters per second (m/s). A second vehicle UE 504 may be traveling in the first direction at 20 m/s, where the second vehicle UE 504 and the first vehicle UE 502 may be separated by a certain distance. A third vehicle UE 506 may be traveling in a second direction (e.g., a direction that is opposite of the first direction) at 20 m/s. The first vehicle UE 502 may transmit a CP-OFDM signal. The first vehicle UE 502 may detect a radar echo from the second vehicle UE 504, which may be based at least in part on the CP-OFDM signal. The first vehicle UE 502 may detect a radar echo from the third vehicle UE 506, which may be based at least in part on the CP-OFDM signal. As a result, the first vehicle UE 502 may be able to detect the second vehicle UE 504 and the third vehicle UE 506.

As indicated above, FIG. 5 is provided as an example. Other examples may differ from what is described with regard to FIG. 5.

Uplink resources may be reused for sensing to enable a UE-side JCR sensing. The uplink resources may be shared between communication and radar modes for sensing on the uplink resources. Separate resources may be used for communication and radar, such as by using a time division multiplexing (TDM) mode. A sounding reference signal (SRS) may be utilized as a waveform. Alternatively, the same resource may be used for communication and radar with a joint co-design waveform.

An automotive use case may involve a relatively high density of vehicular radars with a relatively high resolution and a relatively high update rate. A single phase uplink sensing transmission may lead to a relatively large communication overhead. A two phase uplink sensing with a scanning phase and a tracking phase may enable radar sensing with relatively low overhead. Two phase sensing may be needed to support multi-radar sensing over shared uplink communication resources with relatively low overhead.

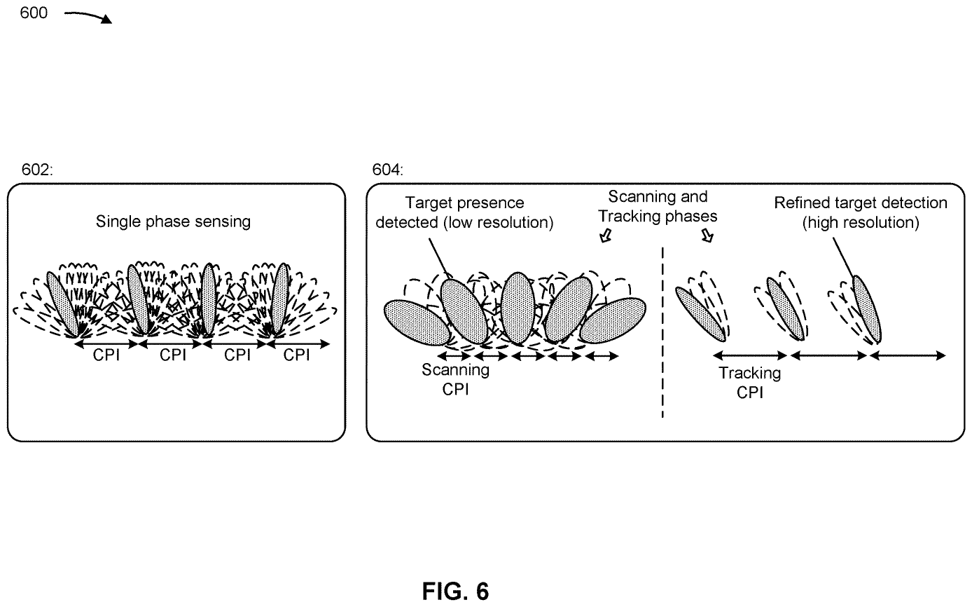

FIG. 6 is a diagram illustrating an example 600 of uplink sensing, in accordance with the present disclosure.

As shown by reference number 602, a single phase uplink sensing may be associated with per-frame requirements. A single phase may be associated with a plurality of coherent processing intervals (CPIs), where a CPI may correspond to a radar frame. As an example, a CPI (per beam) may be associated with a duration of 5.1 ms, a bandwidth of 0.5 GHz, and a subcarrier spacing (SCS) of 120 kHz. For a 20 frames per second (fps) update rate (a 50 ms sensing period), approximately 10% of system resources may be used per beam and per user.

As shown by reference number 604, a two phase uplink sensing may include a scanning phase and a tracking phase. The scanning phase may be associated with a plurality of scanning CPIs. A target presence may be detected (with low resolution) during the scanning phase. The tracking phase may be associated with a plurality of tracking CPIs. A refined target detection (with high resolution) may occur during the scanning phase. As an example, a scanning CPI (per beam) may be associated with a duration of 1 ms, a bandwidth of 150 MHz, and an SCS of 120 kHz. A tracking CPI (per beam) may be associated with a duration of 5 ms, and a bandwidth of 0.5 GHz, with a comb-5 decimation in time (e.g., one in every fifth symbol) and a comb-4 decimation in frequency (e.g., one in every fourth resource element (RE)). For a 20 fps update rate, approximately 4.5% of system resources may be used per user and per detected target, and approximately 9% of system resources may be used per user assuming two targets are within a field of view. Thus, two phase sensing may support multi-radar sensing over shared uplink communication resources with relatively low overhead, as compared to single phase uplink sensing.

As indicated above, FIG. 6 is provided as an example. Other examples may differ from what is described with regard to FIG. 6.

A UE may transmit, to a network node, a buffer status report (BSR), which may indicate information regarding a volume of uplink data waiting to be transferred. In other words, the BSR may indicate an amount of data in an uplink buffer that is available for transmission. The UE may transmit the BSR on a physical uplink shared channel (PUSCH) using a medium access control control element (MAC-CE). A BSR MAC-CE may be a short BSR and truncated BSR MAC-CE, which may indicate a logical channel identifier (LCID) and a corresponding buffer size. The BSR MAC-CE may be a long BSR MAC-CE, which may indicate a plurality of buffer sizes, where a buffer size of the plurality of buffer sizes may correspond to a BSR index for a logical channel group (LCG) (e.g., buffer size #0 is a BSR index for LCG 0, buffer size #1 is a BSR index for LCG 1, and so on). Further, buffer size levels may be defined for the BSR. For example, an index value (e.g., an index value of 1) may correspond to a buffer size value (e.g., a buffer size between 0 and 10 bytes).

A network node may transmit, to a UE, a system information block type 12 (SIB12). The UE may transmit, to the network node and based at least in part on the SIB12, sidelink UE information (Sidelink UEInformationUE) for an NR sidelink communication. The UE may inform the network node, via the sidelink UE information, that the UE is interested or no longer interested to receive or transmit the NR sidelink communication. The UE may inform the network node, via the sidelink UE information, that the UE is requesting an assignment or a release of a transmission resource for the NR sidelink communication. The UE may inform the network node, via the sidelink UE information, that the UE is reporting quality of service (QOS) parameters and QoS profile(s) related to the NR sidelink communication. The UE may inform the network node, via the sidelink UE information, that the UE is reporting that a sidelink radio link failure or a sidelink RRC reconfiguration failure has been detected. The UE may inform the network node, via the sidelink UE information, that the UE is reporting sidelink UE capability information of an associated peer UE for a unicast communication. The UE may inform the network node, via the sidelink UE information, that the UE is reporting RLC mode information of sidelink data radio bearer(s) received from the associated peer UE for the unicast communication.

A UE and a network node may perform an RRC reconfiguration based at least in part on signaling between the UE and the network node. The UE may transmit, to the network node and based at least in part on the RRC reconfiguration, UE assistance information. The UE assistance information may be a special RRC message, which may be used by the UE to inform the network node of various internal statuses of the UE. The network node, based at least in part on the UE assistance information, may assign and/or control resources which are better tailored for a specific time instance of the UE (e.g., when the UE is in a connected mode).

The UE assistance information may be similar to UE capability information, but with a few differences. The UE capability information may be transmitted, by the UE, only in response to a request from the network node, whereas the UE assistance information may be transmitted by the UE without any request from the network node. The UE capability information may be transmitted before the RRC reconfiguration, where the UE capability information may assist the network node to not configure the UE with a feature that is outside of a capability of the UE. The UE assistance information may be transmitted after the RRC reconfiguration, where the UE assistance information may assist the network node to configure parameters that are best fit for the UE for a specific moment or duration. The UE capability information may indicate maximum capabilities of the UE, whereas the UE assistance information may indicate capabilities at specific moments. The UE capability information may be more of a set of static information, whereas the UE assistance information may be more dynamic in nature.

An uplink resource management may only support a communication resource allocation. However, a mechanism for managing uplink resources for sensing is needed, especially given expected sensing services to be offered in 5G systems (e.g., a long range sensing service or a short-range sensing service). Uplink resource management for sensing may be needed to manage uplink resources for sensing (e.g., sensing performed by a UE), which may improve an overall system performance.

In various aspects of techniques and apparatuses described herein, a UE may transmit, to a network node, an indication of a transmission configuration pattern for sensing using uplink resources, a sensing and interference measurement report, and/or a sensing traffic pattern. The network node may determine a transmit resource allocation for sensing, which may be based at least in part on the transmission configuration pattern for sensing using uplink resources, the sensing and interference measurement report, and/or the sensing traffic pattern. The UE may receive, from the network node, an indication of the transmit resource allocation for sensing. The transmit resource allocation for sensing may be based at least in part on an uplink resource management for sensing, which may decrease a likelihood of collisions between multiple UEs, and thereby may improve both a UE and a network performance.

In some aspects, the UE may transmit, to the network node, an RRC message that indicates the transmission configuration pattern for sensing using uplink resources. The RRC message may also indicate a sensing signal bearer group identifier and a sensing target group identifier. In some cases, the UE may transmit, to the network node, both an RRC message and a MAC-CE to indicate the transmission configuration pattern for sensing using uplink resources. For example, multiple transmission configuration patterns for sensing using uplink resources may be indicated using the RRC message and a selection of one of the multiple transmission configuration patterns for sensing using uplink resources may be indicated using the MAC-CE. Additionally, or alternatively, the UE may transmit, to the network node, an RRC message that indicates the sensing and interference measurement report, which may assist the network node in selecting transmit resources needed to be allocated to the UE to achieve a given sensing QoS. Additionally, or alternatively, the UE may transmit, to the network node, an RRC message that indicates the sensing traffic pattern, which may assist the network node in a sensing resource allocation using uplink resources. In some aspects, one or more RRC messages and/or the MAC-CE, which may be transmitted by the UE to the network node and which may indicate the transmission configuration pattern for sensing using uplink resources, the sensing and interference measurement report, and/or the sensing traffic pattern, may enable the uplink resource management for sensing, which may improve an overall system performance.

In some aspects, in an integrated sensing and communication, and in a network-managed mode of radio frequency (RF)-based sensing operation, the UE may request a radio resource allocation from the network node. The UE may reuse a BSR and/or a sidelink BSR, which may be originally designed for communication for a sensing resource management. In order to reuse existing limited BSR fields to signal sensing requirements, the UE may use the one or more RRC messages and/or the MAC-CE to indicate the corresponding meaning of the fields that map to sensing resource requirements, thereby achieving the uplink resource management for sensing.

FIG. 7 is a diagram illustrating an example associated with signaling associated with uplink resources for sensing, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may transmit, to the network node, an indication of a transmission configuration pattern for sensing using uplink resources, a sensing and interference measurement report, and/or a sensing traffic pattern. The UE may transmit the indication of the transmission configuration pattern for sensing using uplink resources, the sensing and interference measurement report, and/or the sensing traffic pattern via one or more RRC messages and/or a MAC-CE. The UE may transmit the indication of the transmission configuration pattern for sensing using uplink resources, the sensing and interference measurement report, and/or the sensing traffic pattern as part of an uplink resource management for sensing.

In some aspects, the UE, when transmitting the indication, may transmit a single RRC message to indicate the transmission configuration pattern for sensing using uplink resources. In some aspects, the UE, when transmitting the indication, may transmit a set of RRC messages to indicate the transmission configuration pattern for sensing using uplink resources. The UE, when transmitting the indication, may transmit, to the network node and via sensing or sidelink UE information, a set of configurable transmission configuration patterns for sensing using uplink resources (e.g., a set of possible transmission configuration patterns). The UE may transmit, to the network node, UE assistance information that indicates a sensing information element (S-IE). The sensing information element may denote an index of the transmission configuration pattern for sensing using uplink resources from the set of configurable transmission configuration patterns for sensing using uplink resources. In some aspects, the UE, when transmitting the indication, may transmit a set of RRC messages and a MAC-CE to indicate the transmission configuration pattern for sensing using uplink resources. The UE, when transmitting the indication, may transmit, to the network node and via sensing or sidelink UE information, a set of configurable transmission configuration patterns for sensing using uplink resources. The UE may transmit, to the network node, the MAC-CE, which may indicate a sensing buffer status report (S-BSR). The S-BSR may denote an index of the transmission configuration pattern for sensing using uplink resources from the set of configurable transmission configuration patterns for sensing using uplink resources.

In some aspects, the UE may transmit one or more RRC messages to the network node (e.g., a controller). The one or more RRC messages may be used to allocate transmission resources for sensing using uplink resources. In some aspects, the single RRC message may be used to transmit, to the network node, the transmission configuration pattern, which may be for sensing using uplink resources. In some aspects, the transmission configuration pattern (or transmit sensing configuration pattern) may be split between the set of RRC messages. For example, the UE may transmit, to the network node, the set of configurable transmission configuration patterns using the sensing or sidelink UE information. The UE may subsequently transmit the UE assistance information, which may indicate the S-IE denoting the index of a particular transmission configuration pattern. In some aspects, the transmission configuration pattern may be split between the set of RRC messages and the MAC-CE. For example, the UE may transmit, to the network node, the set of configurable transmission configuration patterns using the sensing or sidelink UE information. The UE may subsequently transmit the S-BSR denoting the index of a particular transmission configuration pattern. The UE may transmit the S-BSR using the MAC-CE.

In some aspects, the transmission configuration pattern for sensing using uplink resources may indicate time-frequency comb information, beam information, and/or transmit power information. The transmission configuration pattern for sensing using uplink resources may indicate a sensing signal bearer group identifier. The sensing signal bearer group identifier may be based at least in part on a sensing QoS. The sensing QoS may be based at least in part on sensing key performance indicators (KPIs) and/or priority information. In some aspects, the transmission configuration pattern for sensing using uplink resources may indicate a sensing target group identifier. The sensing target group identifier may be based at least in part on a mode of sensing. The mode of sensing may be a monostatic sensing mode, a bistatic sensing mode, or a multi-static sensing mode. The sensing target group identifier may indicate, for the monostatic sensing mode, a group of target objects to be sensed and having common target parameters. The sensing target group identifier may indicate, for the bistatic sensing mode or the multi-static sensing mode, a group of wireless device nodes that are available to assist in sensing and having common device parameters.

In some aspects, the transmission configuration pattern, which may be for sensing using uplink resources, may indicate the time-frequency comb information (e.g., a comb-5 decimation in time in which one in every fifth symbol is used to transmit uplink signals for sensing, and a comb-4 decimation in frequency in which one in every fourth RE is used to transmit uplink signals used for sensing), the beam information (e.g., uplink beams used to transmit uplink signals for sensing), and/or the transmit power information (e.g., a transmit power of uplink signals for sensing). The transmission configuration pattern may indicate the sensing signal bearer group identifier, which may depend on the sensing QoS. The transmission configuration pattern may indicate the sensing target group identifier, which may depend on the mode of sensing (e.g., the monostatic sensing mode or the bistatic/multi-static sensing mode).

In some aspects, the sensing signal bearer group identifier may be based at least in part on the sensing QoS, which may include the sensing KPIs and the priority information. For example, a long range radar (LRR) with a scanning mode may be associated with a first logical channel group (LCG-1) with certain QoS requirements (e.g., a relatively wide field of view and/or a relatively coarse sensing resolution). As another example, an LRR with a tracking mode may be associated with a second logical channel group (LCG-1) with certain QoS requirements (e.g., a relatively narrow field of view and/or a relatively fine sensing resolution). As yet another example, a high priority sensing application, such as a pre-crash application and/or a collision mitigation application, may be associated with a third logical channel group (LCG-3). As a further example, a low priority application, such as a three-dimensional environmental mapping application, may be associated with a fourth logical channel group (LCG-4).

In some aspects, the sensing target group identifier may be based at least in part on the mode of sensing (e.g., a monostatic sensing mode or a bistatic/multi-static sensing mode). For the monostatic sensing mode, the sensing target group identifier may indicate the group of target objects that need to be sensed and have similar target parameters (e.g., location), as compared to each other. For the bistatic/multi-static sensing mode, the sensing target group identifier may indicate the group of wireless device nodes, which may assist in sensing and have similar device parameters (e.g., location), as compared to each other.

In some aspects, the sensing and interference measurement report may indicate a list of measured interference reports in a set of sensing resources. The set of sensing resources may be associated with time-frequency RE groups and beam information. The sensing and interference measurement report may indicate a list of target parameters with a relatively coarse estimation accuracy. In some aspects, the sensing traffic pattern may indicate a sensing QoS identifier, a periodicity of a sensing transmission, a sensing resource size, and/or a timing and frequency offset for a sensing transmission.

In some aspects, one or more RRC messages transmitted by the UE to the network node may indicate the sensing and interference measurement report, which may assist the network node to determine transmit resources to be allocated to achieve the given QoS. The one or more RRC messages may indicate relevant sensing and interference measurement information. The sensing and interference measurement report may indicate the list of measured interference reports in the set of sensing resources. The set of sensing resources may be associated with the time-frequency RE groups and the beam information. The sensing and interference measurement report may indicate the list of target parameters with relatively coarse estimation accuracy.

In some aspects, one or more RRC messages transmitted by the UE to the network node may indicate the sensing traffic pattern, which may assist the network node to determine a transmit resource allocation for sensing (or a sensing resource allocation using uplink resources). The sensing traffic pattern may indicate the sensing QoS identifier. The sensing traffic pattern may indicate the periodicity of the sensing transmission. For example, sensing may be performed every M seconds for a coarse scanning phase. The sensing traffic pattern may indicate the sensing resource size. For example, the sensing resource size may indicate an amount of resources needed in one sensing period in a time-frequency domain, such as the number of REs used for sensing in a boresight direction with a 5 degrees field of view. The sensing traffic pattern may indicate the timing and frequency offset for the sensing transmission.

As shown by reference number 704, the UE may receive, from the network node, an indication of the transmit resource allocation for sensing. The transmit resource allocation for sensing may be based at least in part on the transmission configuration pattern for sensing using uplink resources, the sensing and interference measurement report, and/or the sensing traffic pattern. The indication of the transmit resource allocation for sensing may indicate a sensing resource for achieving a defined QoS. Further, a waveform configuration, a beamforming configuration, and/or a transmit power configuration may be based at least in part on the sensing and interference measurement report.

The network node may use the transmission configuration pattern for sensing using uplink resources, the sensing and interference measurement report, and/or the sensing traffic pattern to select an optimal sensing resource (e.g., a sensing resource that is not used by another UE for sensing, thereby avoiding a collision between multiple UEs). The network node may use the transmission configuration pattern for sensing using uplink resources, the sensing and interference measurement report, and/or the sensing traffic pattern to determine the waveform configuration, the beamforming configuration, and/or the transmit power configuration. The network node may transmit, to the UE, an indication of the optimal sensing resource and the waveform configuration, the beamforming configuration, and/or the transmit power configuration. In other words, the network node may configure the optimal sensing resource, the waveform, the beamforming, and/or the transmit power based at least in part on the transmission configuration pattern for sensing using uplink resources, the sensing and interference measurement report, and/or the sensing traffic pattern. As a result, the network node may support the uplink resource management for sensing based at least in part on the transmission configuration pattern for sensing using uplink resources, the sensing and interference measurement report, and/or the sensing traffic pattern, as received from the UE.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with signaling associated with uplink resources for sensing.

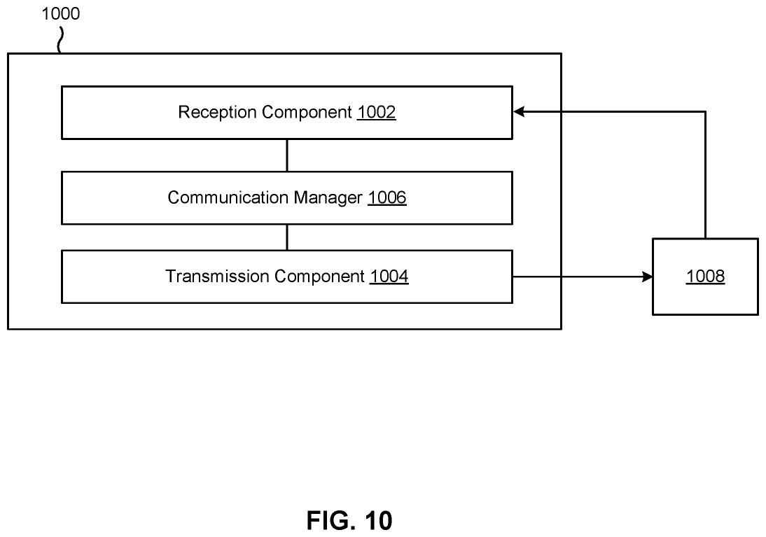

As shown in FIG. 8, in some aspects, process 800 may include transmitting, to a network node, an indication of a transmission configuration pattern for sensing using uplink resources (block 810). For example, the UE (e.g., using transmission component 1004 and/or communication manager 1006, depicted in FIG. 10) may transmit, to a network node, an indication of a transmission configuration pattern for sensing using uplink resources, as described above.

As further shown in FIG. 8, in some aspects, process 800 may include receiving, from the network node, an indication of a transmit resource allocation for sensing, the transmit resource allocation for sensing being based at least in part on the transmission configuration pattern for sensing using uplink resources (block 820). For example, the UE (e.g., using reception component 1002 and/or communication manager 1006, depicted in FIG. 10) may receive, from the network node, an indication of a transmit resource allocation for sensing, the transmit resource allocation for sensing being based at least in part on the transmission configuration pattern for sensing using uplink resources, as described above.

Process 800 may include additional aspects, such as any single aspect or any combination of aspects described below and/or in connection with one or more other processes described elsewhere herein.

In a first aspect, process 800 includes transmitting, to the network node, a single RRC message to indicate the transmission configuration pattern for sensing using uplink resources.

In a second aspect, alone or in combination with the first aspect, process 800 includes transmitting, to the network node, a set of RRC messages to indicate the transmission configuration pattern for sensing using uplink resources.

In a third aspect, alone or in combination with one or more of the first and second aspects, process 800 includes transmitting, to the network node and via sensing or sidelink UE information, a set of configurable transmission configuration patterns for sensing using uplink resources, and transmitting UE assistance information that indicates a sensing information element, the sensing information element denoting an index of the transmission configuration pattern for sensing using uplink resources from the set of configurable transmission configuration patterns for sensing using uplink resources.

In a fourth aspect, alone or in combination with one or more of the first through third aspects, process 800 includes transmitting, to the network node, a set of RRC messages and a MAC-CE to indicate the transmission configuration pattern for sensing using uplink resources.

In a fifth aspect, alone or in combination with one or more of the first through fourth aspects, process 800 includes transmitting, to the network node and via sensing or sidelink UE information, a set of configurable transmission configuration patterns for sensing using uplink resources, and transmitting a MAC-CE that indicates a sensing buffer status report, the sensing buffer status report denoting an index of the transmission configuration pattern for sensing using uplink resources from the set of configurable transmission configuration patterns for sensing using uplink resources.

In a sixth aspect, alone or in combination with one or more of the first through fifth aspects, the transmission configuration pattern for sensing using uplink resources indicates one or more of time-frequency comb information, beam information, or transmit power information.

In a seventh aspect, alone or in combination with one or more of the first through sixth aspects, the transmission configuration pattern for sensing using uplink resources indicates a sensing signal bearer group identifier, wherein the sensing signal bearer group identifier is based at least in part on a sensing quality of service (QOS), and the sensing QoS is based at least in part on one or more of sensing KPIs or priority information.

In an eighth aspect, alone or in combination with one or more of the first through seventh aspects, the transmission configuration pattern for sensing using uplink resources indicates a sensing target group identifier, wherein the sensing target group identifier is based at least in part on a mode of sensing, and the mode of sensing is one of a monostatic sensing mode, a bistatic sensing mode, or a multi-static sensing mode.

In a ninth aspect, alone or in combination with one or more of the first through eighth aspects, the sensing target group identifier indicates, for the monostatic sensing mode, a group of target objects to be sensed and having common target parameters; or the sensing target group identifier indicates, for the bistatic sensing mode or the multi-static sensing mode, a group of wireless device nodes that are available to assist in sensing and having common device parameters.

In a tenth aspect, alone or in combination with one or more of the first through ninth aspects, process 800 includes transmitting, to the network node, a sensing and interference measurement report, wherein the transmit resource allocation for sensing is based at least in part on the sensing and interference measurement report.

In an eleventh aspect, alone or in combination with one or more of the first through tenth aspects, the sensing and interference measurement report indicates a list of measured interference reports in a set of sensing resources, and the set of sensing resources is associated with time-frequency RE groups and beam information; or the sensing and interference measurement report indicates a list of target parameters with a relatively coarse estimation accuracy; and the indication of the transmit resource allocation for sensing indicates a sensing resource for achieving a defined QoS.

In a twelfth aspect, alone or in combination with one or more of the first through eleventh aspects, one or more of a waveform configuration, a beamforming configuration, or a transmit power configuration are based at least in part on the sensing and interference measurement report.

In a thirteenth aspect, alone or in combination with one or more of the first through twelfth aspects, process 800 includes transmitting, to the network node, a sensing traffic pattern, wherein the transmit resource allocation for sensing is based at least in part on the sensing traffic pattern, and the sensing traffic pattern indicates one or more of: a sensing QoS identifier, a periodicity of a sensing transmission, a sensing resource size, or a timing and frequency offset for a sensing transmission.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with signaling associated with uplink resources for sensing.

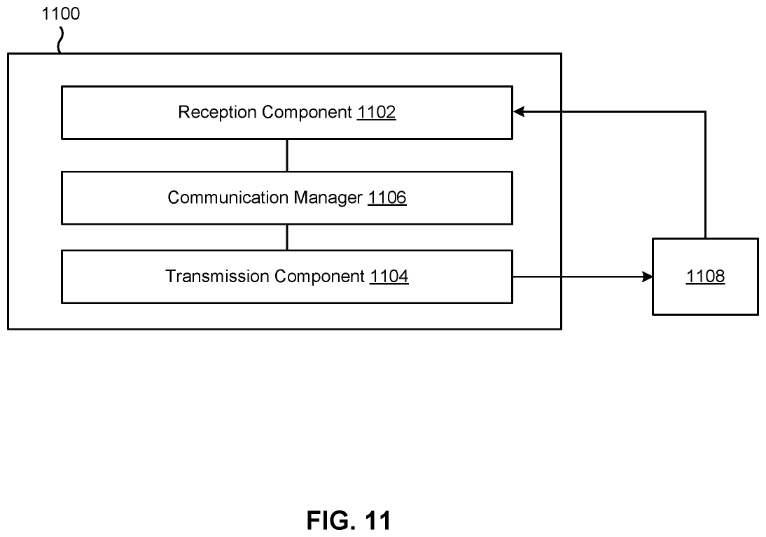

As shown in FIG. 9, in some aspects, process 900 may include receiving, from a UE, an indication of a transmission configuration pattern for sensing using uplink resources (block 910). For example, the network node (e.g., using reception component 1102 and/or communication manager 1106, depicted in FIG. 11) may receive, from a UE, an indication of a transmission configuration pattern for sensing using uplink resources, as described above.

As further shown in FIG. 9, in some aspects, process 900 may include transmitting, to the UE, an indication of a transmit resource allocation for sensing, the transmit resource allocation for sensing being based at least in part on the transmission configuration pattern for sensing using uplink resources (block 920). For example, the network node (e.g., using transmission component 1104 and/or communication manager 1106, depicted in FIG. 11) may transmit, to the UE, an indication of a transmit resource allocation for sensing, the transmit resource allocation for sensing being based at least in part on the transmission configuration pattern for sensing using uplink resources, as described above.

Process 900 may include additional aspects, such as any single aspect or any combination of aspects described below and/or in connection with one or more other processes described elsewhere herein.

In a first aspect, process 900 includes receiving, from the UE, a single RRC message that indicates the transmission configuration pattern for sensing using uplink resources.

In a second aspect, alone or in combination with the first aspect, process 900 includes receiving, from the UE, a set of RRC messages that indicate the transmission configuration pattern for sensing using uplink resources.

In a third aspect, alone or in combination with one or more of the first and second aspects, process 900 includes receiving, from the UE and via sensing or sidelink UE information, a set of configurable transmission configuration patterns for sensing using uplink resources, and receiving UE assistance information that indicates a sensing information element, the sensing information element denoting an index of the transmission configuration pattern for sensing using uplink resources from the set of configurable transmission configuration patterns for sensing using uplink resources.

In a fourth aspect, alone or in combination with one or more of the first through third aspects, process 900 includes receiving, from the UE, a set of RRC messages and a MAC-CE that indicates the transmission configuration pattern for sensing using uplink resources.

In a fifth aspect, alone or in combination with one or more of the first through fourth aspects, process 900 includes receiving, from the UE and via sensing or sidelink UE information, a set of configurable transmission configuration patterns for sensing using uplink resources, and receiving a MAC-CE that indicates a sensing buffer status report, the sensing buffer status report denoting an index of the transmission configuration pattern for sensing using uplink resources from the set of configurable transmission configuration patterns for sensing using uplink resources.

In a sixth aspect, alone or in combination with one or more of the first through fifth aspects, the transmission configuration pattern for sensing using uplink resources indicates one or more of time-frequency comb information, beam information, or transmit power information.

In a seventh aspect, alone or in combination with one or more of the first through sixth aspects, the transmission configuration pattern for sensing using uplink resources indicates a sensing signal bearer group identifier, wherein the sensing signal bearer group identifier is based at least in part on a sensing quality of service (QOS), and the sensing QoS is based at least in part on one or more of sensing KPIs or priority information.

In an eighth aspect, alone or in combination with one or more of the first through seventh aspects, the transmission configuration pattern for sensing using uplink resources indicates a sensing target group identifier, wherein the sensing target group identifier is based at least in part on a mode of sensing, and the mode of sensing is one of a monostatic sensing mode, a bistatic sensing mode, or a multi-static sensing mode.

In a ninth aspect, alone or in combination with one or more of the first through eighth aspects, the sensing target group identifier indicates, for the monostatic sensing mode, a group of target objects to be sensed and having common target parameters; or the sensing target group identifier indicates, for the bistatic sensing mode or the multi-static sensing mode, a group of wireless device nodes that are available to assist in sensing and having common device parameters.

In a tenth aspect, alone or in combination with one or more of the first through ninth aspects, process 900 includes receiving, from the UE, a sensing and interference measurement report, wherein the transmit resource allocation for sensing is based at least in part on the sensing and interference measurement report.

In an eleventh aspect, alone or in combination with one or more of the first through tenth aspects, the sensing and interference measurement report indicates a list of measured interference reports in a set of sensing resources, and the set of sensing resources is associated with time-frequency resource element (RE) groups and beam information; or the sensing and interference measurement report indicates a list of target parameters with a relatively coarse estimation accuracy; and the indication of the transmit resource allocation for sensing indicates a sensing resource for achieving a defined QoS.

In a twelfth aspect, alone or in combination with one or more of the first through eleventh aspects, one or more of a waveform configuration, a beamforming configuration, or a transmit power configuration are based at least in part on the sensing and interference measurement report.

In a thirteenth aspect, alone or in combination with one or more of the first through twelfth aspects, process 900 includes receiving, from the UE, a sensing traffic pattern, wherein the transmit resource allocation for sensing is based at least in part on the sensing traffic pattern, and the sensing traffic pattern indicates one or more of: a sensing QoS identifier, a periodicity of a sensing transmission, a sensing resource size, or a timing and frequency offset for a sensing transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit an indication of a transmission configuration pattern for sensing using uplink resources. The reception component 1002 may receive an indication of a transmit resource allocation for sensing, the transmit resource allocation for sensing being based at least in part on the transmission configuration pattern for sensing using uplink resources.

The transmission component 1004 may transmit a single RRC message to indicate the transmission configuration pattern for sensing using uplink resources. The transmission component 1004 may transmit a set of RRC messages to indicate the transmission configuration pattern for sensing using uplink resources. The transmission component 1004 may transmit, via sensing or sidelink UE information, a set of configurable transmission configuration patterns for sensing using uplink resources. The transmission component 1004 may transmit UE assistance information that indicates a sensing information element, the sensing information element denoting an index of the transmission configuration pattern for sensing using uplink resources from the set of configurable transmission configuration patterns for sensing using uplink resources.

The transmission component 1004 may transmit a set of RRC messages and a MAC-CE to indicate the transmission configuration pattern for sensing using uplink resources. The transmission component 1004 may transmit, via sensing or sidelink UE information, a set of configurable transmission configuration patterns for sensing using uplink resources. The transmission component 1004 may transmit a MAC-CE that indicates a sensing buffer status report, the sensing buffer status report denoting an index of the transmission configuration pattern for sensing using uplink resources from the set of configurable transmission configuration patterns for sensing using uplink resources.

The transmission component 1004 may transmit a sensing and interference measurement report, wherein the transmit resource allocation for sensing is based at least in part on the sensing and interference measurement report. The transmission component 1004 may transmit a sensing traffic pattern, wherein the transmit resource allocation for sensing is based at least in part on the sensing traffic pattern, and the sensing traffic pattern indicates one or more of: a sensing QoS identifier, a periodicity of a sensing transmission, a sensing resource size, or a timing and frequency offset for a sensing transmission.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication of a transmission configuration pattern for sensing using uplink resources. The transmission component 1104 may transmit an indication of a transmit resource allocation for sensing, the transmit resource allocation for sensing being based at least in part on the transmission configuration pattern for sensing using uplink resources.

The reception component 1102 may receive a single RRC message that indicates the transmission configuration pattern for sensing using uplink resources. The reception component 1102 may receive a set of RRC messages that indicate the transmission configuration pattern for sensing using uplink resources. The reception component 1102 may receive, via sensing or sidelink UE information, a set of configurable transmission configuration patterns for sensing using uplink resources. The reception component 1102 may receive UE assistance information that indicates a sensing information element, the sensing information element denoting an index of the transmission configuration pattern for sensing using uplink resources from the set of configurable transmission configuration patterns for sensing using uplink resources.

The reception component 1102 may receive a set of RRC messages and a MAC-CE that indicates the transmission configuration pattern for sensing using uplink resources. The reception component 1102 may receive, via sensing or sidelink UE information, a set of configurable transmission configuration patterns for sensing using uplink resources. The reception component 1102 may receive a MAC-CE that indicates a sensing buffer status report, the sensing buffer status report denoting an index of the transmission configuration pattern for sensing using uplink resources from the set of configurable transmission configuration patterns for sensing using uplink resources.

The reception component 1102 may receive a sensing and interference measurement report, wherein the transmit resource allocation for sensing is based at least in part on the sensing and interference measurement report. The reception component 1102 may receive a sensing traffic pattern, wherein the transmit resource allocation for sensing is based at least in part on the sensing traffic pattern, and the sensing traffic pattern indicates one or more of: a sensing QoS identifier, a periodicity of a sensing transmission, a sensing resource size, or a timing and frequency offset for a sensing transmission.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components.

Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: transmitting, to a network node, an indication of a transmission configuration pattern for sensing using uplink resources; and receiving, from the network node, an indication of a transmit resource allocation for sensing, the transmit resource allocation for sensing being based at least in part on the transmission configuration pattern for sensing using uplink resources.
Aspect 2: The method of Aspect 1, wherein transmitting the indication comprises transmitting, to the network node, a single radio resource control (RRC) message to indicate the transmission configuration pattern for sensing using uplink resources.
Aspect 3: The method of any of Aspects 1-2, wherein transmitting the indication comprises transmitting, to the network node, a set of radio resource control (RRC) messages to indicate the transmission configuration pattern for sensing using uplink resources.
Aspect 4: The method of any of Aspects 1-3, wherein transmitting the indication comprises: transmitting, to the network node and via sensing or sidelink UE information, a set of configurable transmission configuration patterns for sensing using uplink resources; and transmitting UE assistance information that indicates a sensing information element, the sensing information element denoting an index of the transmission configuration pattern for sensing using uplink resources from the set of configurable transmission configuration patterns for sensing using uplink resources.
Aspect 5: The method of any of Aspects 1-4, wherein transmitting the indication comprises transmitting, to the network node, a set of radio resource control (RRC) messages and a medium access control control element (MAC-CE) to indicate the transmission configuration pattern for sensing using uplink resources.
Aspect 6: The method of any of Aspects 1-5, wherein transmitting the indication comprises: transmitting, to the network node and via sensing or sidelink UE information, a set of configurable transmission configuration patterns for sensing using uplink resources; and transmitting a medium access control control element (MAC-CE) that indicates a sensing buffer status report, the sensing buffer status report denoting an index of the transmission configuration pattern for sensing using uplink resources from the set of configurable transmission configuration patterns for sensing using uplink resources.
Aspect 7: The method of any of Aspects 1-6, wherein the transmission configuration pattern for sensing using uplink resources indicates one or more of: time-frequency comb information, beam information, or transmit power information.
Aspect 8: The method of any of Aspects 1-7, wherein the transmission configuration pattern for sensing using uplink resources indicates a sensing signal bearer group identifier, wherein the sensing signal bearer group identifier is based at least in part on a sensing quality of service (QOS), and wherein the sensing QoS is based at least in part on one or more of sensing key performance indicators (KPIs) or priority information.
Aspect 9: The method of any of Aspects 1-8, wherein the transmission configuration pattern for sensing using uplink resources indicates a sensing target group identifier, wherein the sensing target group identifier is based at least in part on a mode of sensing, and wherein the mode of sensing is one of a monostatic sensing mode, a bistatic sensing mode, or a multi-static sensing mode.
Aspect 10: The method of Aspect 9, wherein the sensing target group identifier indicates, for the monostatic sensing mode, a group of target objects to be sensed and having common target parameters; or the sensing target group identifier indicates, for the bistatic sensing mode or the multi-static sensing mode, a group of wireless device nodes that are available to assist in sensing and having common device parameters.
Aspect 11: The method of any of Aspects 1-10, further comprising, transmitting, to the network node, a sensing and interference measurement report, wherein the transmit resource allocation for sensing is based at least in part on the sensing and interference measurement report.
Aspect 12: The method of Aspect 11, wherein: the sensing and interference measurement report indicates a list of measured interference reports in a set of sensing resources, and the set of sensing resources is associated with time-frequency RE groups and beam information; or the sensing and interference measurement report indicates a list of target parameters with a relatively coarse estimation accuracy; and the indication of the transmit resource allocation for sensing indicates a sensing resource for achieving a defined quality of service (QOS).
Aspect 13: The method of Aspect 11, wherein one or more of a waveform configuration, a beamforming configuration, or a transmit power configuration are based at least in part on the sensing and interference measurement report.
Aspect 14: The method of any of Aspects 1-13, further comprising, transmitting, to the network node, a sensing traffic pattern, wherein the transmit resource allocation for sensing is based at least in part on the sensing traffic pattern, and wherein the sensing traffic pattern indicates one or more of: a sensing quality of service (QOS) identifier, a periodicity of a sensing transmission, a sensing resource size, or a timing and frequency offset for a sensing transmission.
Aspect 15: A method of wireless communication performed by a network node, comprising: receiving, from a user equipment (UE), an indication of a transmission configuration pattern for sensing using uplink resources; and transmitting, to the UE, an indication of a transmit resource allocation for sensing, the transmit resource allocation for sensing being based at least in part on the transmission configuration pattern for sensing using uplink resources.
Aspect 16: The method of Aspect 15, wherein receiving the indication comprises receiving, from the UE, a single radio resource control (RRC) message that indicates the transmission configuration pattern for sensing using uplink resources.
Aspect 17: The method of any of Aspects 15-16, wherein receiving the indication comprises receiving a set of radio resource control (RRC) messages that indicate the transmission configuration pattern for sensing using uplink resources.
Aspect 18: The method of any of Aspects 15-17, wherein receiving the indication comprises: receiving, via sensing or sidelink UE information, a set of configurable transmission configuration patterns for sensing using uplink resources; and receiving UE assistance information that indicates a sensing information element, the sensing information element denoting an index of the transmission configuration pattern for sensing using uplink resources from the set of configurable transmission configuration patterns for sensing using uplink resources.
Aspect 19: The method of any of Aspects 15-18, wherein receiving the indication comprises receiving a set of radio resource control (RRC) messages and a medium access control control element (MAC-CE) that indicates the transmission configuration pattern for sensing using uplink resources.
Aspect 20: The method of any of Aspects 15-19, wherein receiving the indication comprises: receiving, via sensing or sidelink UE information, a set of configurable transmission configuration patterns for sensing using uplink resources; and receiving a medium access control control element (MAC-CE) that indicates a sensing buffer status report, the sensing buffer status report denoting an index of the transmission configuration pattern for sensing using uplink resources from the set of configurable transmission configuration patterns for sensing using uplink resources.
Aspect 21: The method of any of Aspects 15-20, wherein the transmission configuration pattern for sensing using uplink resources indicates one or more of: time-frequency comb information, beam information, or transmit power information.
Aspect 22: The method of any of Aspects 15-21, wherein the transmission configuration pattern for sensing using uplink resources indicates a sensing signal bearer group identifier, wherein the sensing signal bearer group identifier is based at least in part on a sensing quality of service (QOS), and wherein the sensing QoS is based at least in part on one or more of sensing key performance indicators (KPIs) or priority information.
Aspect 23: The method of any of Aspects 15-22, wherein the transmission configuration pattern for sensing using uplink resources indicates a sensing target group identifier, wherein the sensing target group identifier is based at least in part on a mode of sensing, and wherein the mode of sensing is one of a monostatic sensing mode, a bistatic sensing mode, or a multi-static sensing mode.
Aspect 24: The method of Aspect 23, wherein the sensing target group identifier indicates, for the monostatic sensing mode, a group of target objects to be sensed and having common target parameters, or the sensing target group identifier indicates, for the bistatic sensing mode or the multi-static sensing mode, a group of wireless device nodes that are available to assist in sensing and having common device parameters.
Aspect 25: The method of any of Aspects 15-24, further comprising: transmitting, to the network node, a sensing and interference measurement report, wherein the transmit resource allocation for sensing is based at least in part on the sensing and interference measurement report.
Aspect 26: The method of Aspect 25, wherein: the sensing and interference measurement report indicates a list of measured interference reports in a set of sensing resources, and the set of sensing resources is associated with time-frequency RE groups and beam information; or the sensing and interference measurement report indicates a list of target parameters with a relatively coarse estimation accuracy; and the indication of the transmit resource allocation for sensing indicates a sensing resource for achieving a defined quality of service (QOS).
Aspect 27: The method of Aspect 25, wherein one or more of a waveform configuration, a beamforming configuration, or a transmit power configuration are based at least in part on the sensing and interference measurement report.
Aspect 28: The method of any of Aspects 15-27, further comprising: transmitting, to the network node, a sensing traffic pattern, wherein the transmit resource allocation for sensing is based at least in part on the sensing traffic pattern, and wherein the sensing traffic pattern indicates one or more of: a sensing quality of service (QOS) identifier, a periodicity of a sensing transmission, a sensing resource size, or a timing and frequency offset for a sensing transmission.
Aspect 29: An apparatus for wireless communication at a device, comprising a processor; memory coupled with the processor; and instructions stored in the memory and executable by the processor to cause the apparatus to perform the method of one or more of Aspects 1-14.
Aspect 30: A device for wireless communication, comprising a memory and one or more processors coupled to the memory, the one or more processors configured to perform the method of one or more of Aspects 1-14.
Aspect 31: An apparatus for wireless communication, comprising at least one means for performing the method of one or more of Aspects 1-14.
Aspect 32: A non-transitory computer-readable medium storing code for wireless communication, the code comprising instructions executable by a processor to perform the method of one or more of Aspects 1-14.
Aspect 33: A non-transitory computer-readable medium storing a set of instructions for wireless communication, the set of instructions comprising one or more instructions that, when executed by one or more processors of a device, cause the device to perform the method of one or more of Aspects 1-14.
Aspect 34: An apparatus for wireless communication at a device, comprising a processor; memory coupled with the processor; and instructions stored in the memory and executable by the processor to cause the apparatus to perform the method of one or more of Aspects 15-28.
Aspect 35: A device for wireless communication, comprising a memory and one or more processors coupled to the memory, the one or more processors configured to perform the method of one or more of Aspects 15-28.
Aspect 36: An apparatus for wireless communication, comprising at least one means for performing the method of one or more of Aspects 15-28.
Aspect 37: A non-transitory computer-readable medium storing code for wireless communication, the code comprising instructions executable by a processor to perform the method of one or more of Aspects 15-28.
Aspect 38: A non-transitory computer-readable medium storing a set of instructions for wireless communication, the set of instructions comprising one or more instructions that, when executed by one or more processors of a device, cause the device to perform the method of one or more of Aspects 15-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more processors;
one or more memories coupled with the one or more processors; and
instructions stored in the one or more memories and executable by the one or more processors, individually or in combination, to cause the apparatus to:
transmit, to a network node, an indication of a transmission configuration pattern for sensing using uplink resources; and
receive, from the network node, an indication of a transmit resource allocation for sensing, the transmit resource allocation for sensing being based at least in part on the transmission configuration pattern for sensing using uplink resources.

2. The apparatus of claim 1, wherein the instructions stored in the one or more memories and executable by the one or more processors, individually or in combination, to transmit the indication, are configured to cause the apparatus to:
transmit, to the network node, a single radio resource control (RRC) message to indicate the transmission configuration pattern for sensing using uplink resources.

3. The apparatus of claim 1, wherein the instructions stored in the one or more memories and executable by the one or more processors, individually or in combination, to transmit the indication, are configured to cause the apparatus to:
transmit, to the network node, a set of radio resource control (RRC) messages to indicate the transmission configuration pattern for sensing using uplink resources.

4. The apparatus of claim 1, wherein the instructions stored in the one or more memories and executable by the one or more processors, individually or in combination, to transmit the indication, are configured to cause the apparatus to:
transmit, to the network node and via sensing or sidelink UE information, a set of configurable transmission configuration patterns for sensing using uplink resources; and
transmit, to the network node, UE assistance information that indicates a sensing information element, the sensing information element denoting an index of the transmission configuration pattern for sensing using uplink resources from the set of configurable transmission configuration patterns for sensing using uplink resources.

5. The apparatus of claim 1, wherein the instructions stored in the one or more memories and executable by the one or more processors, individually or in combination, to transmit the indication, are configured to cause the apparatus to:
transmit, to the network node, a set of radio resource control (RRC) messages and a medium access control control element (MAC-CE) to indicate the transmission configuration pattern for sensing using uplink resources.

6. The apparatus of claim 1, wherein the instructions stored in the one or more memories and executable by the one or more processors, individually or in combination, to transmit the indication, are configured to cause the apparatus to: transmit, to the network node and via sensing or sidelink UE information, a set of configurable transmission configuration patterns for sensing using uplink resources; and
transmit, to the network node, a medium access control control element (MAC-CE) that indicates a sensing buffer status report, the sensing buffer status report denoting an index of the transmission configuration pattern for sensing using uplink resources from the set of configurable transmission configuration patterns for sensing using uplink resources.

7. The apparatus of claim 1, wherein the transmission configuration pattern for sensing using uplink resources indicates one or more of: time-frequency comb information, beam information, or transmit power information.

8. The apparatus of claim 1, wherein the transmission configuration pattern for sensing using uplink resources indicates a sensing signal bearer group identifier, wherein the sensing signal bearer group identifier is based at least in part on a sensing quality of service (QOS), and wherein the sensing QoS is based at least in part on one or more of sensing key performance indicators (KPIs) or priority information.

9. The apparatus of claim 1, wherein the transmission configuration pattern for sensing using uplink resources indicates a sensing target group identifier, wherein the sensing target group identifier is based at least in part on a mode of sensing, and wherein the mode of sensing is one of a monostatic sensing mode, a bistatic sensing mode, or a multi-static sensing mode.

10. The apparatus of claim 9, wherein:
the sensing target group identifier indicates, for the monostatic sensing mode, a group of target objects to be sensed and having common target parameters; or the sensing target group identifier indicates, for the bistatic sensing mode or the multi-static sensing mode, a group of wireless device nodes that are available to assist in sensing and having common device parameters.

11. The apparatus of claim 1, wherein the instructions stored in the one or more memories and executable by the one or more processors, individually or in combination, are further configured to cause the apparatus to:
transmit, to the network node, a sensing and interference measurement report, wherein the transmit resource allocation for sensing is based at least in part on the sensing and interference measurement report.

12. The apparatus of claim 11, wherein:
the sensing and interference measurement report indicates a list of measured interference reports in a set of sensing resources, and the set of sensing resources is associated with time-frequency resource element (RE) groups and beam information; or the sensing and interference measurement report indicates a list of target parameters with a relatively coarse estimation accuracy; and
the indication of the transmit resource allocation for sensing indicates a sensing resource for achieving a defined quality of service (QOS).

13. The apparatus of claim 11, wherein one or more of a waveform configuration, a beamforming configuration, or a transmit power configuration are based at least in part on the sensing and interference measurement report.

14. The apparatus of claim 1, wherein the instructions stored in the one or more memories and executable by the one or more processors, individually or in combination, are further configured to cause the apparatus to: transmit, to the network node, a sensing traffic pattern, wherein the transmit resource allocation for sensing is based at least in part on the sensing traffic pattern, and wherein the sensing traffic pattern indicates one or more of: a sensing quality of service (QOS) identifier, a periodicity of a sensing transmission, a sensing resource size, or a timing and frequency offset for a sensing transmission.

15. An apparatus for wireless communication at a network node, comprising:
one or more processors;
one or more memories coupled with the one or more processors; and
instructions stored in the one or more memories and executable by the one or more processors, individually or in combination, to cause the apparatus to:
receive, from a user equipment (UE), an indication of a transmission configuration pattern for sensing using uplink resources; and
transmit, to the UE, an indication of a transmit resource allocation for sensing, the transmit resource allocation for sensing being based at least in part on the transmission configuration pattern for sensing using uplink resources.

16. The apparatus of claim 15, wherein the instructions stored in the one or more memories and executable by the one or more processors, individually or in combination, to receive the indication, are configured to cause the apparatus to:
receive, from the UE, a single radio resource control (RRC) message that indicates the transmission configuration pattern for sensing using uplink resources.

17. The apparatus of claim 15, wherein the instructions stored in the one or more memories and executable by the one or more processors, individually or in combination, to receive the indication, are configured to cause the apparatus to:
receive, from the UE, a set of radio resource control (RRC) messages that indicate the transmission configuration pattern for sensing using uplink resources.

18. The apparatus of claim 15, wherein the instructions stored in the one or more memories and executable by the one or more processors, individually or in combination, to receive the indication, are configured to cause the apparatus to:
receive, from the UE and via sensing or sidelink UE information, a set of configurable transmission configuration patterns for sensing using uplink resources; and
receive, from the UE, UE assistance information that indicates a sensing information element, the sensing information element denoting an index of the transmission configuration pattern for sensing using uplink resources from the set of configurable transmission configuration patterns for sensing using uplink resources.

19. The apparatus of claim 15, wherein the instructions stored in the one or more memories and executable by the one or more processors, individually or in combination, to receive the indication, are configured to cause the apparatus to:
receive, from the UE, a set of radio resource control (RRC) messages and a medium access control control element (MAC-CE) that indicates the transmission configuration pattern for sensing using uplink resources.

20. The apparatus of claim 15, wherein the instructions stored in the one or more memories and executable by the one or more processors, individually or in combination, to receive the indication, are configured to cause the apparatus to:
receive, from the UE and via sensing or sidelink UE information, a set of configurable transmission configuration patterns for sensing using uplink resources; and
receive, from the UE, a medium access control control element (MAC-CE) that indicates a sensing buffer status report, the sensing buffer status report denoting an index of the transmission configuration pattern for sensing using uplink resources from the set of configurable transmission configuration patterns for sensing using uplink resources.

21-30. (canceled)
